(19) United States
(12) Patent Application Publication
(10) Pub. No.: US 2026/0057641 A1
(43) Pub. Date: Feb. 26, 2026

(54) OBJECT RECOGNITION METHOD AND OBJECT RECOGNITION DEVICE

(71) Applicant: PEGATRON CORPORATION, TAIPEI CITY (TW)

(72) Inventor: Po-Sen Chen, Taipei City (TW)

(73) Assignee: PEGATRON CORPORATION, TAIPEI CITY (TW)

(21) Appl. No.: 19/218,626

(22) Filed: May 27, 2025

(30) Foreign Application Priority Data
Aug. 21, 2024 (TW) 113131480

(51) Int. Cl. G06V 10/56; G06V 10/77; G06V 10/82; G06V 40/20; H04N 25/47

(52) U.S. Cl. CPC G06V 10/56; G06V 10/7715; G06V 10/82; G06V 40/23; H04N 25/47

(57) ABSTRACT

An object recognition method and an object recognition device are provided. The method includes: obtaining a dynamic vision sensor (DVS) image, and converting a DVS image into a color image using an image conversion model; extracting a first feature map of the DVS image, and extracting a second feature map of the color image; fusing the first feature map and the second feature map into a third feature map; and performing an object recognition operation on the third feature map using an object recognition model to obtain an object recognition result corresponding to the DVS image.

### CROSS-REFERENCE TO RELATED APPLICATION

This application claims the priority benefit of Taiwan application serial no. 113131480, filed on Aug. 21, 2024. The entirety of the above-mentioned patent application is hereby incorporated by reference herein and made a part of this specification.

### BACKGROUND

### Technical Field

The disclosure relates to an object recognition mechanism, and more particularly to an object recognition method and an object recognition device.

### Description of Related Art

The objective of the traditional human posture detection method is to find human joint points in a color image (also referred to as an RGB image) or a video. Using the joint points, whether a person is standing, sitting, lying down, or performing certain activities may be predicted, and an application such as fall detection, gait analysis, and motion capture may be further developed. Currently, the most advanced human posture detection methods are all based on the RGB images or the videos for analysis, because there are a large number of data sets available for model training and verification, which can effectively improve the accuracy of human posture detection.

The objective of the event camera, also referred to as the dynamic vision sensor (DVS), is to sensitively capture a moving object. Since the DVS has the characteristic of privacy protection, the DVS may be used in an environment where privacy is required, such as a bathroom, for fall detection. In order to implement relevant applications, existing studies attempt to input DVS image data into a human posture detection model developed based on a convolutional neural network (CNN) to find the joint points.

Although there are literatures that explore how to use the DVS for human posture detection, the error value is much higher (about 20% to 30%) than that of traditional RGB cameras, because the existing human posture detection methods are all trained and developed based on the RGB images. However, due to large differences between DVS images and the RGB images, the existing human posture detection methods cannot be directly applied to the DVS images.

As such, a large amount of DVS image data needs to be collected again, and the human joint points are marked to train and develop the corresponding human posture detection model. However, due to the high noise, the low resolution, and the poor signal quality of the DVS image data, the error value is too high and the application scope is limited. Therefore, DVS-related products are not yet popular. Due to the challenges, it is difficult to directly adopt a posture estimation method of the RGB images to improve the accuracy of joint point detection for the DVS images.

### SUMMARY

The disclosure provides an object recognition method and an object recognition device, which may be used to solve the above technical issues.

An embodiment of the disclosure provides an object recognition method applied to an object recognition device and including the following steps. A dynamic vision sensor image is obtained, and the dynamic vision sensor image is converted into a color image using an image conversion model. A first feature map of the dynamic vision sensor image is extracted, and a second feature map of the color image is extracted. The first feature map and the second feature map are fused into a third feature map. An object recognition operation is performed on the third feature map using an object recognition model to obtain an object recognition result corresponding to the dynamic vision sensor image.

An embodiment of the disclosure provides an object recognition device including a storage circuit and a processor. The storage circuit stores a program code. The processor is coupled to the storage circuit and accesses the program code to execute the following operations. A dynamic vision sensor image is obtained, and the dynamic vision sensor image is converted into a color image using an image conversion model. A first feature map of the dynamic vision sensor image is extracted, and a second feature map of the color image is extracted. The first feature map and the second feature map are fused into a third feature map. An object recognition operation is performed on the third feature map using an object recognition model to obtain an object recognition result corresponding to the dynamic vision sensor image.

### BRIEF DESCRIPTION OF THE DRAWINGS

FIG. 1 is a schematic diagram of an object recognition device according to an embodiment of the disclosure.

FIG. 2 is a schematic diagram of generating a DVS image according to an embodiment of the disclosure.

FIG. 3 is a flowchart of an object recognition method according to an embodiment of the disclosure.

FIG. 4 is an application scenario diagram according to an embodiment of the disclosure.

FIG. 5A is a schematic diagram of implementing an image conversion model with a vision transformer according to an embodiment of the disclosure.

FIG. 5B is a schematic diagram of implementing an object recognition model with another vision transformer according to an embodiment of the disclosure.

### DESCRIPTION OF THE EMBODIMENTS

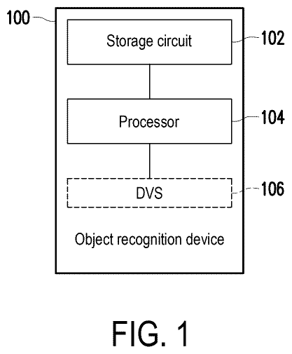

Please refer to FIG. 1, which is a schematic diagram of an object recognition device according to an embodiment of the disclosure. In different embodiments, an object recognition device 100 may be implemented as, for example, various smart devices and/or computer devices, but not limited thereto.

In FIG. 1, the object recognition device 100 may include a storage circuit 102 and a processor 104.

The storage circuit 102 is, for example, any type of fixed or removable random-access memory (RAM), read-only memory (ROM), flash memory, hard disk, other similar devices, or a combination of the devices and may be used to record multiple program codes or modules.

The processor 104 is coupled to the storage circuit 102 and may be a general purpose processor, a specific purpose processor, a conventional processor, a digital signal processor, multiple microprocessors, one or more microprocessors, controllers, microcontrollers, application specific integrated circuits (ASIC), or field programmable gate arrays (FPGA) in combination with a digital signal processor core, any other type of integrated circuit, a state machine, a processor based on an advanced reduced instruction set computer (RISC) machine (ARM), and the like.

In some embodiments, the object recognition device 100 may further include a DVS 106 coupled to the processor 104, wherein the DVS 106 may be used to collect multiple events occurring within a time interval, and each event includes corresponding pixel coordinates, event time, and polarity. Furthermore, the processor 104 may generate a DVS image through integrating the events.

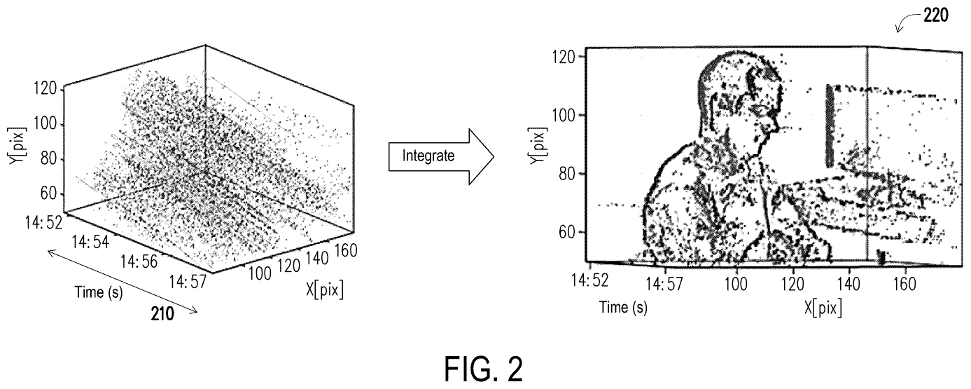

Please refer to FIG. 2, which is a schematic diagram of generating a DVS image according to an embodiment of the disclosure.

In an embodiment of the disclosure, a working mechanism of the DVS 106 is, for example, that when a brightness value of a position where a certain pixel is at changes, an event may be returned, and the event may include the coordinates (including the corresponding X and Y coordinate components) of the pixel, the time when the event occurs, and the polarity. In an embodiment, the polarity of the event may take the value of a first value or a second value (wherein the first value and the second value may respectively be 0 or 1 or respectively be −1 or 1), wherein the polarity presented as the first value represents that the brightness of the pixel is from low to high (also referred to as a positive event), and the polarity presented as the second value represents that the brightness of the pixel is from high to low (also referred to as a negative event).

In FIG. 2, a time interval 210 considered is, for example, “14:52” to “14:57”, each point in the left half of FIG. 2 corresponds to one event, the X and Y coordinate components corresponding to each point is the pixel position where the brightness value changes, and the position corresponding to each point on the time axis is the time when the brightness value changes. In addition, the lighter dots in the left half of FIG. 2 correspond to the events with the polarity of the first value, and the darker dots correspond to the events with the polarity of the second value, but not limited thereto.

In FIG. 2, the processor 104 may generate a DVS image 220 through integrating the events within the time interval 210. In an embodiment, the processor 104 may temporally overlap the events within the time interval 210 to generate the DVS image 220, but not limited thereto.

It can be seen from the DVS image 220 of FIG. 2 that there should be a human within an imaging range of the DVS 106. However, as mentioned above, since existing human posture detection methods are all trained and developed based on RGB images, if the existing human posture detection methods are directly used to recognize the DVS image 220, an accurate human posture recognition result cannot be obtained.

In view of this, the disclosure provides an object recognition method, which may be used to solve the above technical issues. In an embodiment of the disclosure, the processor 104 may access modules and program codes recorded in the storage circuit 102 to implement the object recognition method provided by the disclosure, the details of which are described as follows.

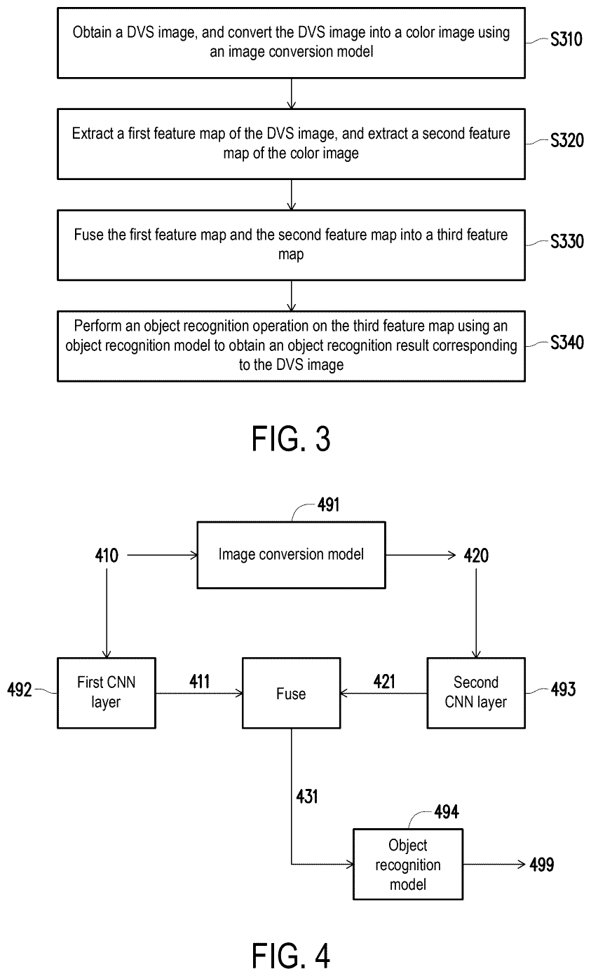

Please refer to FIG. 3, which is a flowchart of an object recognition method according to an embodiment of the disclosure. The method of the embodiment may be executed by the object recognition device 100 of FIG. 1. The following describes the details of each step of FIG. 3 with reference to the elements shown in FIG. 1. In addition, in order to facilitate understanding of the concept of the disclosure, FIG. 4 will be further supplemented for illustration below, wherein FIG. 4 is an application scenario diagram according to an embodiment of the disclosure.

First, in step S310, the processor 104 obtains a DVS image 410, and converts the DVS image 410 into a color image 420 using an image conversion model 491. In an embodiment, the DVS image 410 is, for example, the DVS image 220 including the human as shown in FIG. 2, but not limited thereto.

In some embodiments, the processor 104 may obtain the DVS image 410 in a manner similar to the manner of obtaining the DVS image 220 described above. In other embodiments, the processor 104 may also obtain the DVS image 410 through directly reading the DVS image 410 stored in the storage circuit 102, but not limited thereto.

In an embodiment of the disclosure, the image conversion model 491 may, for example, be implemented as various deep learning models, machine learning models, and neural networks, and have the ability to convert any DVS image into a corresponding color image, but not limited thereto.

In an embodiment, in order for the image conversion model 491 to have the above ability, during a training process of the image conversion model 491, a designer may feed specially designed training data into the image conversion model 491, so that the image conversion model 491 may perform corresponding learning. For example, after obtaining a certain DVS image, the designer may fill in the DVS image with colors to generate a corresponding color image, and label the DVS image as corresponding to the color image, thereby forming one piece of training data. After generating multiple pieces of training data based on similar techniques, the processor 104 may feed the training data into the image conversion model 491, so that the image conversion model 491 may learn what type of DVS image corresponds to what type of color image.

Therefore, when a new DVS image (for example, the DVS image 410) is fed into the trained image conversion model 491, the image conversion model 491 may correspondingly predict/judge/generate a corresponding color image (for example, the color image 420), but not limited thereto.

Furthermore, the training mechanism may be understood as training the image conversion model 491 based on the concept of supervised learning. Therefore, the DVS images and the corresponding RGB images (which may be understood as standard answers) need to be first collected and marked, and the images are fed into the image conversion model 491 being trained. Afterwards, a prediction error is judged through comparing the RGB image predicted by the image conversion model 491 with the standard answer, and the prediction error is fed back into the image conversion model 491 to adjust weights of neurons. Th process needs to be continuously repeated based on a large amount of training data until the prediction result is close to the standard answer.

In step S320, the processor 104 extracts a first feature map 411 of the DVS image 410, and extracts a second feature map 421 of the color image 420.

In the scenario of FIG. 4, the processor 104 feeds the DVS image 410 into multiple first convolutional neural network (CNN) layers 492, wherein the first CNN layers 492 output the first feature map 411 in response to the DVS image 410.

Similarly, the processor 104 may feed the color image 420 into a second CNN layer 493, wherein the second CNN layer 493 outputs the second feature map 421 in response to the color image 420.

In other embodiments, the processor 104 may also apply different types of feature extraction mechanisms, such as autoencoder, generative adversarial network (GAN), vision transformer, feature pyramid network (FPN), and residual neural network (ResNet), to extract the first feature map 411 and/or the second feature map 421, but not limited thereto.

In step S330, the processor 104 fuses the first feature map 411 and the second feature map 421 into a third feature map 431.

In an embodiment of the disclosure, the processor 104 may fuse the first feature map 411 and the second feature map 421 into the third feature map 431 using different manners, such as additive fusion, concatenated fusion, weighted additive fusion, multiplicative fusion, and average fusion, according to the requirements of the designer, but not limited thereto.

In step S340, the processor 104 performs an object recognition operation on the third feature map 431 using an object recognition model 494 to obtain an object recognition result 499 corresponding to the DVS image 410.

In an embodiment of the disclosure, the object recognition model 494 may, for example, be implemented as various deep learning models, machine learning models, and neural networks, and have the ability to perform the corresponding object recognition operations based on the received feature map, but not limited thereto.

In an embodiment, in order for the object recognition model 494 to have the above ability, during a training process of the object recognition model 494, the designer may feed specially designed training data into the object recognition model 494, so that the object recognition model 494 may perform corresponding learning. For example, the designer may label a certain feature map corresponding to a certain specific object recognition result and the specific object recognition result as one piece of training data, the feature map may have the same dimension as the third feature map 431, for example, and the specific object recognition result may be, for example, a certain specific human posture detection result, but not limited thereto.

After generating multiple pieces of training data based on similar techniques, the processor 104 may feed the training data into the object recognition model 494, so that the object recognition model 494 may learn which type of feature map corresponds to which type of object recognition result.

Therefore, when a new feature map (for example, the third feature map 431) is fed into the trained object recognition model 494, the object recognition model 494 may correspondingly predict/judge/generate a corresponding object recognition result (for example, the object recognition result 499), but not limited thereto.

Furthermore, the training mechanism may be understood as training the object recognition model 494 based on the concept of supervised learning. Therefore, the feature maps and the corresponding object recognition results (for example, marked human joint points, which may be understood as the standard answers) need to be first collected and marked, and the feature maps are fed into the object recognition model 494 being trained. Afterwards, a prediction error is judged through comparing the object recognition result predicted by the object recognition model 494 with the standard answer, and the prediction error is fed back into the object recognition model 494 to adjust weights of neurons. The process needs to be continuously repeated based on a large amount of training data until the prediction result is close to the standard answer.

In an embodiment, the object recognition result 499 is, for example, the human posture detection result corresponding to the DVS image 410 and may be embodied as a human skeleton diagram including multiple joint points, but not limited thereto.

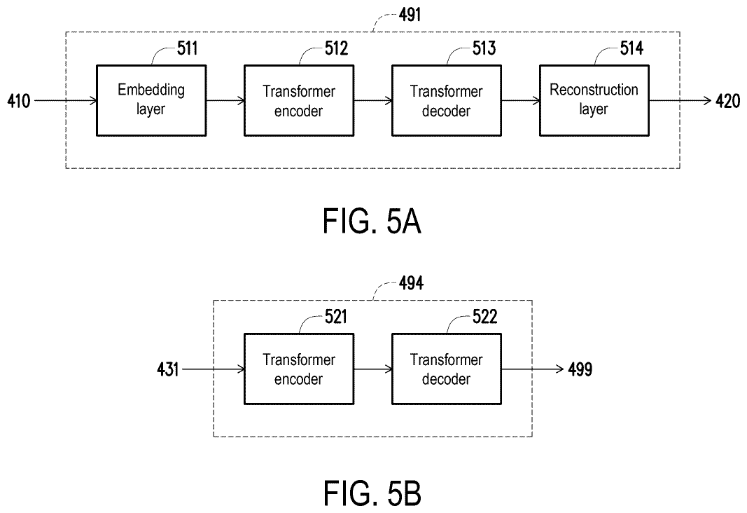

Please refer to FIG. 5A, which is a schematic diagram of implementing an image conversion model with a vision transformer according to an embodiment of the disclosure.

In FIG. 5A, the image conversion model 491 may be, for example, a vision transformer and may include an embedding layer 511, a transformer encoder 512, a transformer decoder 513, and a reconstruction layer 514, wherein the embedding layer 511 is used to receive the DVS image 410, and the reconstruction layer 514 is used to output the color image 420.

In an embodiment of the disclosure, the embedding layer 511, the transformer encoder 512, the transformer decoder 513, and the reconstruction layer 514 may, for example, be implemented based on the content disclosed in the literature “Dosovitskiy, Alexey, et al. ‘An image is worth 16×16 words: Transformers for image recognition at scale.’”, but not limited thereto.

Please refer to FIG. 5B, which is a schematic diagram of implementing an object recognition model with another vision transformer according to an embodiment of the disclosure.

In FIG. 5B, the object recognition model 494 may be, for example, another vision transformer and may include a transformer encoder 521 and a transformer decoder 522, wherein the transformer encoder 521 is used to receive the third feature map 431, and the transformer decoder 522 is used to generate the object recognition result 499 corresponding to the DVS image 410 in response to an output of the transformer encoder 52, but not limited thereto.

In an embodiment of the disclosure, the transformer encoder 521 and the transformer decoder 522 may, for example, be implemented based on the content disclosed in the literature “Xu, Yufei, et al. ‘Vitpose: Simple vision transformer baselines for human pose estimation.’”, but not limited thereto.

In different embodiments, the object recognition result 499 may be adjusted to a result of recognizing any object in response to the requirements of the designer and is not limited to the human posture detection result exemplified above.

In summary, in the object recognition method according to the embodiment of the disclosure, the image conversion model may be first used to convert the obtained DVS image into the corresponding color image, and the feature maps of the DVS image and the corresponding color image may be individually extracted. Afterwards, after fusing the individual feature maps of the DVS image and the color image, the required object recognition operation may be performed based on the fused feature map, and the corresponding object recognition result (for example, the human posture detection result) may be obtained.

Since the method of the disclosure considers the feature maps of both the DVS image and the color image when performing the object recognition operation, the method of the disclosure can achieve more accurate object recognition result than directly performing the object recognition operation on the DVS image with the existing object detection model.

Although the disclosure has been disclosed in the above embodiments, the embodiments are not intended to limit the disclosure. Persons skilled in the art may make some changes and modifications without departing from the spirit and scope of the disclosure. Therefore, the protection scope of the disclosure shall be defined by the appended claims.

What is claimed is:

1. An object recognition method, applied to an object recognition device, comprising:
obtaining a dynamic vision sensor image, and converting the dynamic vision sensor image into a color image using an image conversion model;
extracting a first feature map of the dynamic vision sensor image, and extracting a second feature map of the color image;
fusing the first feature map and the second feature map into a third feature map; and
performing an object recognition operation on the third feature map using an object recognition model to obtain an object recognition result corresponding to the dynamic vision sensor image.

2. The object recognition method according to claim 1, wherein obtaining the dynamic vision sensor image comprises:
collecting a plurality of events occurring within a time interval using a dynamic vision sensor, wherein each of the events comprises corresponding pixel coordinates, event time, and polarity; and
generating the dynamic vision sensor image through integrating the events.

3. The object recognition method according to claim 1, wherein extracting the first feature map of the dynamic vision sensor image comprises:
feeding the dynamic vision sensor image into a plurality of first convolutional neural network layers, wherein the first convolutional neural network layers output the first feature map in response to the dynamic vision sensor image.

4. The object recognition method according to claim 1, wherein extracting the second feature map of the color image comprises:
feeding the color image into a second convolutional neural network layer, wherein the second convolutional neural network layer outputs the second feature map in response to the color image.

5. The object recognition method according to claim 1, wherein the image conversion model comprises a vision transformer, and the object recognition result corresponding to the dynamic vision sensor image is a human posture detection result.

6. An object recognition device, comprising:
a non-transitory storage circuit, storing a program code;
a processor, coupled to the non-transitory storage circuit and accessing the program code to execute:
obtaining a dynamic vision sensor image, and converting the dynamic vision sensor image into a color image using an image conversion model;
extracting a first feature map of the dynamic vision sensor image, and extracting a second feature map of the color image;
fusing the first feature map and the second feature map into a third feature map; and
performing an object recognition operation on the third feature map using an object recognition model to obtain an object recognition result corresponding to the dynamic vision sensor image.

7. The object recognition device according to claim 6, further comprising a dynamic vision sensor coupled to the processor, wherein the processor is configured to execute:
controlling the dynamic vision sensor to collect a plurality of events occurring within a time interval, wherein each of the events comprises corresponding pixel coordinates, event time, and polarity; and
generating the dynamic vision sensor image through integrating the events.

8. The object recognition device according to claim 6, wherein the processor is configured to execute:
feeding the dynamic vision sensor image into a plurality of first convolutional neural network layers, wherein the first convolutional neural network layers output the first feature map in response to the dynamic vision sensor image.

9. The object recognition device according to claim 6, wherein the processor is configured to execute:
feeding the color image into a second convolutional neural network layer, wherein the second convolutional neural network layer outputs the second feature map in response to the color image.

10. The object recognition device according to claim 6, wherein the image conversion model comprises a vision transformer, and the object recognition result corresponding to the dynamic vision sensor image is a human posture detection result.
